(19) United States
(12) Patent Application Publication
(10) Pub. No.: US 2025/0294579 A1
(43) Pub. Date: Sep. 18, 2025

(54) Method And Apparatus For Scheduling Of Multi-Cell Uplink And Downlink Transmissions With Two-Segment Downlink Control Information

(71) Applicant: MediaTek Inc., Hsinchu City (TW)

(72) Inventor: Chi-Hsuan Hsieh, Hsinchu City (TW)

(21) Appl. No.: 18/859,535

(22) PCT Filed: Apr. 21, 2023
(86) PCT No.: PCT/CN2023/089641

§ 371 Date: Oct. 23, 2024

Related U.S. Application Data
(60) Provisional application No. 63/336,399, filed on Apr. 29, 2022.

(30) Foreign Application Priority Data
Apr. 21, 2023 (WO) PCT/CN2023/089641

(51) Int. Cl. H04W 72/232; H04L 5/00

(52) U.S. Cl. CPC H04W 72/232; H04L 5/0044

(57) ABSTRACT

Various solutions for improvement of a scheduling of multi-cell PUSCH/PDSCH transmission with a two-segment DCI are described. An apparatus may receive a two-segment DCI indicating a scheduling of a plurality of cells from a network node of a wireless network. The two-segment DCI includes a first DCI and a second DCI. The first DCI includes a common bit field and a first part of a designated bit fields corresponding to at least one of the plurality of cells. The second DCI includes a second part of the designated bit fields corresponding to at least one of the plurality of cells. The apparatus may perform a PDSCH reception or a PUSCH transmission with at least one of the plurality of cells based on the two-segment DCI.

### CROSS REFERENCE TO RELATED PATENT APPLICATION(S)

The present disclosure is part of U.S. National Stage filing of International Patent Application No. PCT/CN2023/089641, filed 21 Apr. 2023, which claims the priority benefit of U.S. Provisional Patent Application No. 63/336,399, filed on 29 Apr. 2022. The content of aforementioned application is herein incorporated by reference in its entirety.

### TECHNICAL FIELD

The present disclosure is generally related to mobile communications and, more particularly, to improve a scheduling of multi-cell uplink (UL) and downlink (DL) transmissions with a two-segment downlink control information (DCI).

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using a plurality of cells forming a radio access network. The BS may support the operations of the plurality of cells, and each cell may be operable to provide services to at least one user equipment (UE) within its radio coverage. Specifically, each cell may provide services to serve one or more UEs within its radio coverage based on at least one DCI, where a radio coverage of one cell may overlap with another radio coverage of other cell(s). In one example, each cell may schedule a DL/UL resource to one UE within its radio coverage by one DCI for performing a DL/UL transmission. If the UE can support more than one cells (e.g., in dual connectivity/carrier aggregation), the UE may receive more than one DCI for scheduling DL/UL transmissions with the more than one cells. As that, the network and the BS have to configure a plurality of DCIs corresponding to the plurality of cells respectively to the UE, so as to schedule resources for the DL/UL transmissions between the UE and the cells, which may lack of transmission efficiency and waste available network resources. In addition, there is a bit number limit for decoding the DCI if one specific decoding technique (e.g., polar decoding technique) is utilized by the UE. Accordingly, a field number/size of the DCI should comply with a bit-limit rule/regulation.

Accordingly, how to improve a scheduling of multi-cell UL (e.g., physical uplink shared channel, PUSCH)/DL (e.g., physical downlink shared channel, PDSCH) transmissions with a single DCI complying with the bit-limit rule/regulation becomes an important issue for the newly developed wireless communication network. Therefore, there is a need to provide a proper DCI structure/segment design to improve scheduling efficiency.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to improvement of a scheduling of multi-cell UL (e.g., PUSCH)/DL (e.g., PDSCH) transmissions with a two-segment DCI.

In one aspect, a method may involve a processor of an apparatus receiving a two-segment DCI indicating a scheduling of a plurality of cells from a network node of a wireless network. The two-segment DCI includes a first DCI and a second DCI. The first DCI includes a common bit field and a first part of a designated bit fields corresponding to at least one of the plurality of cells. The second DCI includes a second part of the designated bit fields corresponding to at least one of the plurality of cells. The method may also involve the processor of the apparatus performing a PDSCH reception or a PUSCH transmission with at least one of the plurality of cells based on the two-segment DCI.

In one aspect, an apparatus may include a transceiver which, during operation, wirelessly communicates with a network node of a wireless network. The apparatus may also comprise a processor communicatively coupled to the transceiver. The processor, during operation, may perform operations including receiving a two-segment DCI indicating a scheduling of a plurality of cells from a network node of a wireless network. The two-segment DCI includes a first DCI and a second DCI. The first DCI includes a common bit field and a first part of a designated bit fields corresponding to at least one of the plurality of cells. The second DCI includes a second part of the designated bit fields corresponding to at least one of the plurality of cells. The processor, during operation, may also perform operations including performing a PDSCH reception or a PUSCH transmission with at least one of the plurality of cells based on the two-segment DCI.

In one aspect, a method may involve a processor of a network node configuring a two-segment DCI indicating a scheduling of a plurality of cells. The two-segment DCI includes a first DCI and a second DCI. The first DCI includes a common bit field and a first part of a designated bit fields corresponding to at least one of the plurality of cells. The second DCI includes a second part of the designated bit fields corresponding to at least one of the plurality of cells. The method may also involve the processor of the network node transmitting the two-segment DCI to an apparatus of a wireless network to schedule a PDSCH reception or a PUSCH transmission with at least one of the plurality of cells based on the two-segment DCI.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a DCI reception corresponding to a plurality of cells in accordance with the present disclosure.

FIG. 2 is a diagram depicting an example scenario illustrating a two-segment DCI in accordance with the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement of a scheduling of multi-cell UL (e.g., PUSCH)/DL (e.g., PDSCH) transmissions with a two-segment DCI. According to the present disclosure, a number of possible solutions may be implemented separately or jointly. That is, although these possible solutions may be described below separately, two or more of these possible solutions may be implemented in one combination or another.

In 3^{rd} Generation Partnership Project (3GPP), a radio access network (e.g., 5G NR access network) may include a plurality of BSs (e.g., Next Generation Node-Bs (gNBs)) to communicate with a plurality of mobile stations referred as UEs. For current network implementations, one BS is operable to provide radio coverage to a specific geographical area using a plurality of cells forming a radio access network. The BS may support the operations of the plurality of cells, and each cell may be operable to provide services to at least one UE within its radio coverage. Specifically, each cell may provide services to serve one or more UEs within its radio coverage based on at least one DCI, where a radio coverage of one cell may overlap with another radio coverage of other cell(s). In one example, each cell may schedule a DL/UL resource to one UE within its radio coverage by one DCI for performing a DL/UL transmission. If the UE can support more than one cell (e.g., application in dual connectivity/carrier aggregation), the UE may receive more than one DCI for scheduling DL/UL transmissions with the more than one cells.

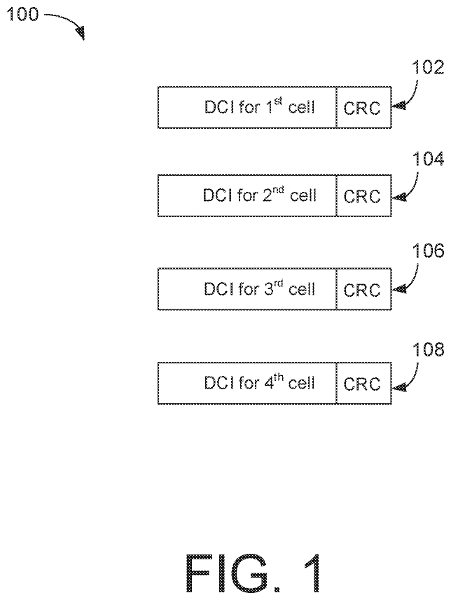

FIG. 1 illustrates an example scenario 100 of a DCI reception corresponding to a plurality of cells in accordance with the present disclosure. As shown in scenario 100, at least one BS may serve the UE for providing four DCIs 102, 104, 106 and 108. Specifically, the DCI 102 is utilized for a scheduling of a 1^{st} cell with the UE, the DCI 104 is utilized for a scheduling of a 2^{nd} cell with the UE, the DCI 106 is utilized for a scheduling of a 3^{rd} cell with the UE, and the DCI 108 is utilized for a scheduling of a 4^{th} cell with the UE. In one example, each DCI is attached with a cyclic redundancy check (CRC) for error decoding, and includes at least one designated bit field (e.g., 60 bits) and one CRC field (e.g., 24 bits), where the designated bit field includes a scheduling information for one cell. As that, the UE may communicate with the four cells (e.g., 1^{st} cell, 2^{nd} cell, 3^{rd} cell and 4^{th} cell) and perform a PDSCH reception or a PUSCH transmission scheduled by the four DCIs 102, 104, 106 and 108, respectively.

Based on different transmissions and capabilities of the UE, the network and the BS may configure a plurality of DCIs corresponding to a plurality of cells respectively to the UE, so as to schedule relevant resources for the DL/UL transmissions between the UE and the cells. However, it seems less efficient if the network resource(s) may not be enough to serve all UEs within the radio coverages. In addition, there is a bit number limit (e.g., less than 140 bits) for decoding the DCI if one specific decoding technique (e.g., polar decoding technique) is utilized by the UE. As that, it is proposed with a two-segment DCI that aggregates the four DCIs received in scenario 100 for a scheduling of multi-cell UL (e.g., PUSCH)/DL (e.g., PDSCH) transmission(s).

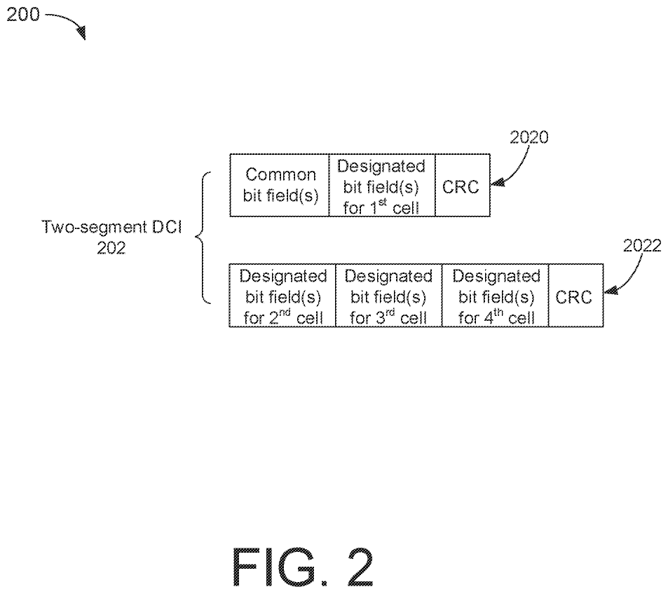

FIG. 2 illustrates an example scenario 200 illustrating a two-segment DCI 202 in accordance with implementations of the present disclosure. As shown in scenario 200, the implementation in scenario 200 being similar to scenario 100 may include at least one BS serving the UE with four cells (e.g., 1^{st} cell, 2^{nd} cell, 3^{rd} cell and 4^{th} cell), and the difference is that the BS in the scenario 200 applying with a two-segment DCI scheme may configure a two-segment DCI 202 that aggregates the four DCIs and schedules transmissions with the four cells (e.g., 1^{st} cell, 2^{nd} cell, 3^{rd} cell and 4^{th} cell). In one example, the UE may receive the two-segment DCI 202 via one cell (e.g., 1st cell), and the other cells (e.g., 2^{nd} cell, 3^{rd} cell and 4^{th} cell) are scheduled by the same two-segment DCI 202 received in the previous cell (e.g., 1^{st} cell). Since the UE may utilize one specific decoding technique (e.g., polar decoding technique) for decoding the two-segment DCI 202, the network and/or the BS may adaptively configure a field number/size of the two-segment DCI 202 complying with the bit-limit rule/regulation (e.g., less than 140 bits).

In some implementations, based on the bit-limit rule/regulation, the two-segment DCI 202 may include two DCI segments (e.g., first DCI 2020 and second DCI 2022), and the UE may link both the two DCI segments (e.g., first DCI 2020 and second DCI 2022) together while decoding the DCI for scheduling information therein. Specifically, the first DCI 2020 may include a common bit field, a first part of designated bit fields corresponding to at least one of the four cells and the CRC bit field, and the second DCI 2022 may include a second part of designated bit fields corresponding to at least one of the four cells and the CRC bit field. In one example, the first DCI 2020 may have one designated bit field corresponding to one cell (e.g., 1^{st} cell), and the second DCI 2022 may have at least three designated bit fields corresponding to other three cells (e.g., 2^{nd} cell, 3^{rd} cell and 4^{th} cell).

In some implementations, the UE may receive a radio resource control (RRC), a medium access control (MAC) control element (CE), another DCI being different from the first DCI 2020 and the second DCI 2022, or a pre-determined field number (and/or specified in a predetermined rule) in any signaling/indication from the BS, to configure which DCI field(s) to be the common bit field(s) and which DCI field(s) to be the designated bit field(s), i.e., the UE may adaptively determine field numbers for the common bit field and the plurality of designated bit fields in the first DCI 2020 and the second DCI 2022. Specifically, for multi-cell PUSCH/PDSCH scheduling, the network and/or the BS may utilize at least one of the RRC, the MAC CE, one additional DCI and the pre-determined field number to assign which field(s) inside the two-segment DCI 202 to be the common bit field(s) or to be the designated bit field(s). In addition, the network and/or the BS may independently assign the fields of the first DCI 2020/second DCI 2022 for each of the scheduled cells (e.g., 1^{st} cell, 2^{nd} cell, 3^{rd} cell and 4^{th} cell).

In some implementations, based on different transmissions and the number of scheduled cell(s), the network and/or the BS may adaptively configure which DCI field(s) to be the common bit field(s)/designated bit field(s) and/or the field numbers for the common bit field(s)/designated bit field(s) of the two-segment DCI 202 by any of the above signaling/indications. In one example, the common bit field may be configured as 2, and the designated bit field may be configured as 4 for each cell. In another example, the common bit field may have 24 bits, and the designated bit field may have 36 bits for each cell, which is not limited hereinafter.

In some implementations, under the two-segment DCI scheme, the UE may receive the first DCI 2020 and the second DCI 2022 on the same cell (e.g., 1^{st} cell) for decoding, respectively. While decoding the first DCI 2020 and the second DCI 2022, the UE may perform a link procedure to link the first DCI 2020 and the second DCI 2022. Specifically, the common bit field in the first DCI 2020 may be linked with one or more of the plurality of designated bit fields in the first DCI 2020 or the second DCI 2022, so as to decode/obtain a scheduling information corresponding to one of the four cells (e.g., 1^{st} cell). As that, based on the scheduling information indicated by the first DCI 2020 and/or the second DCI 2022 corresponding to one of the plurality of cells (e.g., 1^{st} cell), the UE may perform the PDSCH reception or the PUSCH transmission with the cell (e.g., 1^{st} cell).

In some implementations, under the two-segment DCI scheme, the UE may receive a scheduling type of received DCIs from the BS before performing the link procedure. Specifically, the scheduling type may include a DL scheduling as a DL scheduling DCI or a UL scheduling as a UL scheduling DCI, and the UE may perform the link procedure for the received DCIs if two of the received DCIs have the same scheduling type. In one example, the UE may receive four DCIs including a first UL scheduling DCI, a first DL scheduling DCI, a second UL scheduling DCI and a second DL scheduling DCI. Based on the scheduling type of the four DCIs, the UE may classify the first UL scheduling DCI and the second UL scheduling DCI into a first group having the same UL scheduling and classify the first DL scheduling DCI and the second DL scheduling DCI into a second group having the same DL scheduling. As that, while performing the link procedure for the first group, the UE may link the common bit field of the first UL scheduling DCI with one or more of the designated bit fields from the first UL scheduling DCI or from the second UL scheduling DCI. In addition, while performing the link procedure for the second group, the UE may link the common bit field of the first DL scheduling DCI with one or more of the designated bit fields from the first DL scheduling DCI or from the second DL scheduling DCI, which is not limited hereinafter.

In some implementations, under the two-segment DCI scheme, the UE may receive a DCI identification (ID) value or a carrier identification field (CIF) indicated in received DCIs from the BS before performing the link procedure. In one example, if two received DCIs (e.g., the first DCI 2020 and the second DCI 2022) have the same DCI ID value or have the same CIF, the UE may perform the link procedure for the two received DCIs (e.g., the first DCI 2020 and the second DCI 2022), so as to link the common bit field of one DCI (e.g., the first DCI 2020) with one or more of the designated bit fields from the one DCI (e.g., the first DCI 2020) or from the other DCI (e.g., the second DCI 2022).

In some implementations, while monitoring a physical downlink control channel (PDCCH) with the two-segment DCI scheme, the UE may receive a scrambling sequence of a demodulation reference signal (DMRS) from the BS before performing the link procedure, where the DMRS is utilized to scramble the PDCCH carrying one or more DCIs (e.g., the first DCI 2020 and the second DCI 2022). In one example, if two DCIs (e.g., the first DCI 2020 and the second DCI 2022) have the same scrambling sequence, the UE may perform the link procedure for the two DCIs (e.g., the first DCI 2020 and the second DCI 2022), so as to link the common bit field of one DCI (e.g., the first DCI 2020) with one or more of the designated bit fields from the one DCI (e.g., the first DCI 2020) or from the other DCI (e.g., the second DCI 2022).

In some implementations, under the two-segment DCI scheme, the BS may configure a reception symbol and/or a reception period (i.e., having a same starting symbol with a same duration of symbols) for the UE monitoring DCI(s). In one example, if two DCIs (e.g., the first DCI 2020 and the second DCI 2022) are received in the same reception symbol and/or in the same reception period, the UE may determine that the two DCIs applying the two-segment DCI scheme are relevant for combination and link the common bit field of one DCI (e.g., the first DCI 2020) with one or more of the designated bit fields from the one DCI (e.g., the first DCI 2020) or from the other DCI (e.g., the second DCI 2022). In another example, under the two-segment DCI scheme, the BS may transmit two DCIs (e.g., the first DCI 2020 and the second DCI 2022) in a same transmission symbol and/or in a same transmission period. As that, in response to receiving the two DCIs (e.g., the first DCI 2020 and the second DCI 2022) in the same transmission symbol/period, the UE may determine that the two DCIs applying with the two-segment DCI scheme are relevant for combination and link the common bit field of one DCI (e.g., the first DCI 2020) with one or more of the designated bit fields from the one DCI (e.g., the first DCI 2020) or from the other DCI (e.g., the second DCI 2022).

Accordingly, while the BS may transmit more DCIs to the UE under the two-segment DCI scheme, at least one of the above mechanisms/operations may be configured to the UE to identify which type of the DCI it is (e.g., being the first DCI 2020 having the common bit field as well as the designated bit field(s), or being the second DCI 2022 having the designated bit field(s) only) and to determine how to adaptively perform the link procedure for the common bit field/designated bit field(s) inside the received DCIs by different indications, which is not limited hereinafter.

In some implementations, being similar to scenario 200 with the two-segment DCI scheme and complying with the bit-limit rule/regulation, if the UE is able to support more cells (e.g., more than four cells), the UE may receive at least one additional DCI from the BS, and the at least one additional DCI being different from the first DCI 2020/second DCI 2022 may include a similar field format that may include at least one designated bit field corresponding to at least one additional cell as well as the CRC bit field. In one example, after receiving the DCIs (e.g., the first DCI segment 2020, the second DCI 2022 and a third DCI), the UE may perform the link procedure to link the first DCI 2020 with the second DCI 2022 or with the at least one additional DCI (e.g., the third DCI), so as to decode/obtain scheduling information from the received DCIs for performing the PDSCH reception or the PUSCH transmission with more cells.

Therefore, based on the two-segment DCI scheme and the bit-limit rule/regulation, the BS and/or the network may adaptively transmit a minimum number of DCIs (e.g., two as the first DCI 2020 and the second DCI 2022) to the UE, and the UE may correspondingly link the received DCIs for decoding scheduling information, so as to perform UL/DL transmissions (e.g., PUSCH and/or PDSCH) with the multiple cells. Due to the improved scheduling of multi-cell UL (e.g., PUSCH)/DL (e.g., PDSCH) transmissions with the two-segment DCI, a more efficiency transmission may be anticipated without wasting available resources of the network.

### Illustrative Implementations

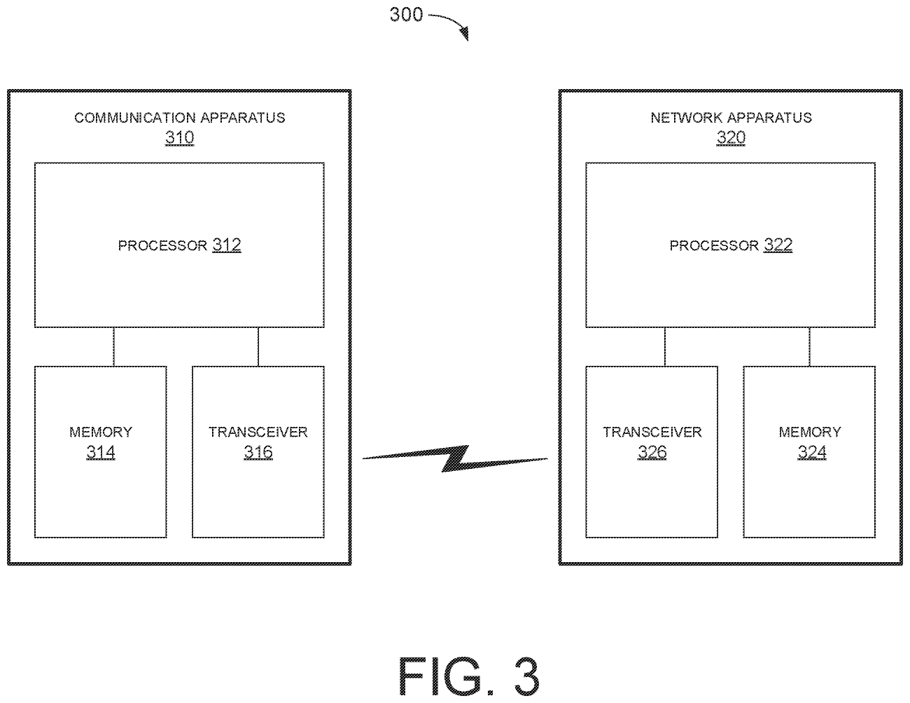

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to improvement of a scheduling of multi-cell UL (e.g., PUSCH)/DL (e.g., PDSCH) transmissions with a two-segment DCI, including scenarios/schemes described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may receive, via transceiver 316, a two-segment DCI indicating a scheduling of a plurality of cells from the network apparatus 320. The two-segment DCI includes a first DCI and a second DCI. The first DCI includes a common bit field and a first part of a designated bit fields corresponding to at least one of the plurality of cells. The second DCI includes a second part of the designated bit fields corresponding to at least one of the plurality of cells. Then, processor 312 may perform a PDSCH reception or a PUSCH transmission with at least one of the plurality of cells based on the two-segment DCI.

In some implementations, processor 312 may receive, via transceiver 316, an RRC, a MAC CE, a third DCI, or a pre-determined field number from the network apparatus 320 to configure which DCI field to be the common bit field and which DCI fields to be the plurality of designated bit fields.

In some implementations, processor 312 may perform a link procedure to link the first DCI with the second DCI as the two-segment DCI for performing the PDSCH reception or the PUSCH transmission with the at least one of the plurality of cells. The first DCI and the second DCI are decoded on a same cell before performing the link procedure. The link procedure is operated to link the common bit field of the first DCI with one or more of the designated bit fields from the first DCI or from the second DCI as the two-segment DCI.

In some implementations, processor 312 may receive, via transceiver 316, a scheduling type of the first DCI or the second DCI from the network apparatus 320. Then, the processor 312 may link the common bit field of the first DCI with one or more of the designated bit fields from the first DCI or from the second DCI in an event that the scheduling types of the first DCI and the second DCI are the same.

In some implementations, processor 312 may receive, via transceiver 316, a DCI ID value or a CIF of the first DCI or of the second DCI from the network apparatus 320. Then, the processor 312 may link the common bit field of the first DCI with one or more of the designated bit fields from the first DCI or from the second DCI in an event that the first DCI and the second DCI have the same DCI ID value or the same CIF.

In some implementations, processor 312 may receive, via transceiver 316, a scrambling sequence of a DMRS scrambled PDCCH carrying the first DCI or the second DCI from the network apparatus 320. Then, the processor 312 may link the common bit field of the first DCI with one or more of the designated bit fields from the first DCI or from the second DCI in an event that the first DCI and the second DCI have the same scrambling sequence.

In some implementations, processor 312 may determine a reception symbol or a reception period of the first DCI or of the second DCI. Then, the processor 312 may link the common bit field of the first DCI with one or more of the designated bit fields from the first DCI or from the second DCI in an event that the first DCI and the second DCI are received in the same reception symbol or in the same reception period.

In some implementations, processor 312 may receive, via transceiver 316, at least one fourth DCI from the network apparatus 320. Then, the processor 312 may perform the link procedure to link the first DCI with the second DCI or with the at least one fourth DCI for performing the PDSCH reception or the PUSCH transmission with the at least one of the plurality of cells.

In some implementations, processor 322 may configure a two-segment DCI indicating a scheduling of a plurality of cells. The two-segment DCI includes a first DCI and a second DCI. The first DCI includes a common bit field and a first part of a designated bit fields corresponding to at least one of the plurality of cells. The second DCI includes a second part of the designated bit fields corresponding to at least one of the plurality of cells. Then, processor 322 may transmit, via transceiver 326, the two-segment DCI to the communication apparatus 310 to schedule a PDSCH reception or a PUSCH transmission with at least one of the plurality of cells based on the two-segment DCI.

In some implementations, processor 322 may transmit, via transceiver 326, an RRC, a MAC CE, a third DCI, or a pre-determined field number to the communication apparatus 310 to configure which DCI field to be the common bit field and which DCI fields to be the plurality of designated bit fields.

In some implementations, the two-segment DCI is formed by performing a link procedure to link the first DCI with the second DCI. The first DCI and the second DCI are decoded on a same cell before performing the link procedure. The link procedure is operated by the communication apparatus 310 to link the common bit field of the first DCI with one or more of the designated bit fields from the first DCI or from the second DCI as the two-segment DCI.

In some implementations, processor 322 may transmit, via transceiver 326, a scheduling type of the first DCI or the second DCI to the communication apparatus 310. Processor 322 may transmit, via transceiver 326, a DCI ID value or a CIF of the first DCI or of the second DCI to the communication apparatus 310. Processor 322 may transmit, via transceiver 326, a scrambling sequence of a DMRS scrambled PDCCH carrying the first DCI or the second DCI to the communication apparatus 310. Processor 322 may transmit, via transceiver 326, at least one fourth DCI to the communication apparatus 310. Processor 322 may configure a transmission symbol or a transmission period of the first DCI or of the second DCI.

### Illustrative Processes

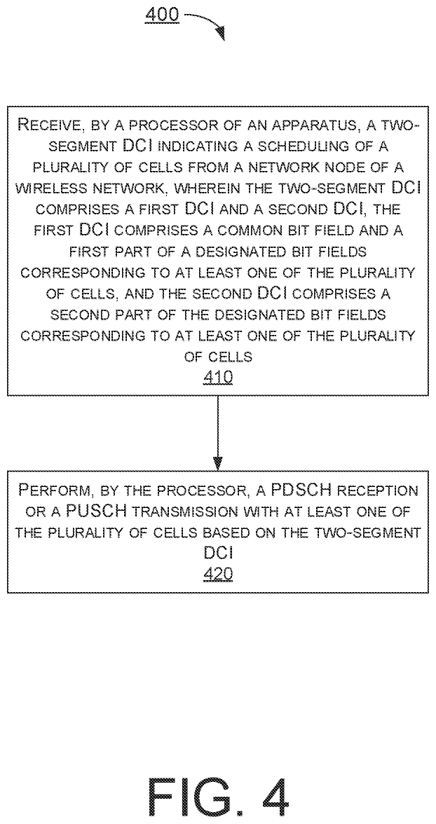

FIG. 4 illustrates an example process 400 in accordance with an implementation of the present disclosure. Process 400 may be an example implementation of above scenarios/schemes, whether partially or completely, with respect to improvement of a scheduling of multi-cell UL (e.g., PUSCH)/DL (e.g., PDSCH) transmissions with a two-segment DCI. Process 400 may represent an aspect of implementation of features of communication apparatus 310. Process 400 may include one or more operations, actions, or functions as illustrated by one or more of blocks 410 to 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 receiving a two-segment DCI indicating a scheduling of a plurality of cells from a network node (e.g., network apparatus 320) of a wireless network, wherein the two-segment DCI includes a first DCI and a second DCI, the first DCI includes a common bit field and a first part of a designated bit fields corresponding to at least one of the plurality of cells, and the second DCI includes a second part of the designated bit fields corresponding to at least one of the plurality of cells. Process 400 may proceed from 410 to 420.

At 420, process 400 may involve processor 312 performing a PDSCH reception or a PUSCH transmission with at least one of the plurality of cells based on the two-segment DCI.

In some implementations, process 400 may further involve processor 312 receiving an RRC, a MAC CE, a third DCI, or a pre-determined field number from the network node (e.g., network apparatus 320) to configure which DCI field to be the common bit field and which DCI fields to be the plurality of designated bit fields.

In some implementations, process 400 may further involve processor 312 performing a link procedure to link the first DCI with the second DCI as the two-segment DCI for performing the PDSCH reception or the PUSCH transmission with the at least one of the plurality of cells, wherein the first DCI and the second DCI are decoded on a same cell before performing the link procedure, and the link procedure is operated to link the common bit field of the first DCI with one or more of the designated bit fields from the first DCI or from the second DCI as the two-segment DCI.

In some implementations, process 400 may further involve processor 312 receiving a scheduling type of the first DCI or the second DCI from the network node (e.g., network apparatus 320). Then, process 400 may further involve processor 312 linking the common bit field of the first DCI with one or more of the designated bit fields from the first DCI or from the second DCI in an event that the scheduling types of the first DCI and the second DCI are the same.

In some implementations, process 400 may further involve processor 312 receiving a DCI ID value or a CIF of the first DCI or of the second DCI from the network node (e.g., network apparatus 320). Then, process 400 may further involve processor 312 linking the common bit field of the first DCI with one or more of the designated bit fields from the first DCI or from the second DCI in an event that the first DCI and the second DCI have the same DCI ID value or the same CIF.

In some implementations, process 400 may further involve processor 312 receiving a scrambling sequence of a DMRS scrambled PDCCH carrying the first DCI or the second DCI from the network node (e.g., network apparatus 320). Then, process 400 may further involve processor 312 linking the common bit field of the first DCI with one or more of the designated bit fields from the first DCI or from the second DCI in an event that the first DCI and the second DCI have the same scrambling sequence.

In some implementations, process 400 may further involve processor 312 determining a reception symbol or a reception period of the first DCI or of the second DCI. Then, process 400 may further involve processor 312 linking the common bit field of the first DCI with one or more of the designated bit fields from the first DCI or from the second DCI in an event that the first DCI and the second DCI are received in the same reception symbol or in the same reception period.

In some implementations, process 400 may further involve processor 312 receiving at least one fourth DCI from the network node (e.g., network apparatus 320). Then, process 400 may further involve processor 312 performing the link procedure to link the first DCI with the second DCI or with the at least one fourth DCI for performing the PDSCH reception or the PUSCH transmission with the at least one of the plurality of cells.

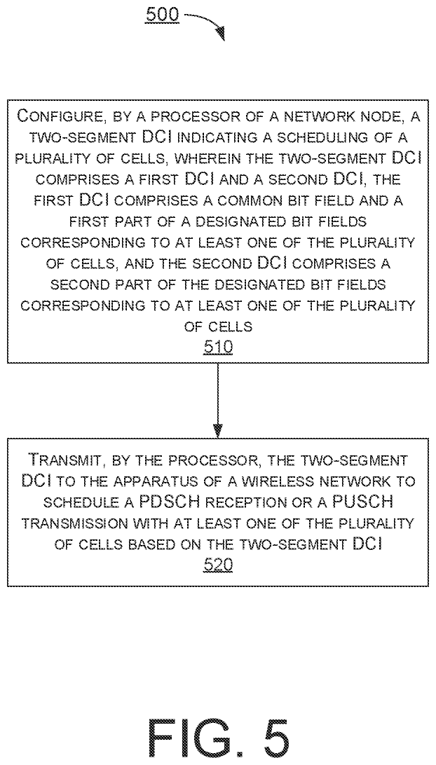

FIG. 5 illustrates an example process 500 in accordance with an implementation of the present disclosure. Process 500 may be an example implementation of above scenarios/schemes, whether partially or completely, with respect to improvement of a scheduling of multi-cell UL (e.g., PUSCH)/DL (e.g., PDSCH) transmissions with a two-segment DCI. Process 500 may represent an aspect of implementation of features of network apparatus 320. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any suitable BS or network nodes. Solely for illustrative purposes and without limitation, process 500 is described below in the context of network apparatus 320. Process 500 may begin at block 510.

At 510, process 500 may involve processor 322 of network apparatus 320 configuring a two-segment DCI indicating a scheduling of a plurality of cells to an apparatus (e.g., communication apparatus 310) of a wireless network, wherein the two-segment DCI includes a first DCI and a second DCI, the first DCI includes a common bit field and a first part of a designated bit fields corresponding to at least one of the plurality of cells, and the second DCI includes a second part of the designated bit fields corresponding to at least one of the plurality of cells. Process 500 may proceed from 510 to 520.

At 520, process 500 may involve processor 322 transmitting the two-segment DCI to the apparatus (e.g., communication apparatus 310) to schedule a PDSCH reception or a PUSCH transmission with at least one of the plurality of cells based on the two-segment DCI.

In some implementations, process 500 may further involve processor 322 transmitting an RRC, a MAC CE, a third DCI, or a pre-determined field number to the apparatus (e.g., communication apparatus 310) to configure which DCI field to be the common bit field and which DCI fields to be the plurality of designated bit fields.

In some implementations, the two-segment DCI is formed by performing a link procedure to link the first DCI with the second DCI, the first DCI and the second DCI are decoded on a same cell before performing the link procedure, and the link procedure is operated by the apparatus to link the common bit field of the first DCI with one or more of the designated bit fields from the first DCI or from the second DCI as the two-segment DCI.

In some implementations, process 500 may further involve processor 322 transmitting a scheduling type of the first DCI or the second DCI to the apparatus (e.g., communication apparatus 310). Process 500 may further involve processor 322 transmitting a DCI ID value or a CIF of the first DCI or of the second DCI to the apparatus (e.g., communication apparatus 310). Process 500 may further involve processor 322 transmitting a scrambling sequence of a DMRS scrambled PDCCH carrying the first DCI or the second DCI to the apparatus (e.g., communication apparatus 310). Process 500 may further involve processor 322 transmitting at least one fourth DCI to the apparatus (e.g., communication apparatus 310). Process 500 may further involve processor 322 configuring a transmission symbol or a transmission period of the first DCI or of the second DCI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a two-segment downlink control information (DCI) indicating a scheduling of a plurality of cells from a network node of a wireless network, wherein the two-segment DCI comprises a first DCI and a second DCI, the first DCI comprises a common bit field and a first part of a designated bit fields corresponding to at least one of the plurality of cells, and the second DCI comprises a second part of the designated bit fields corresponding to at least one of the plurality of cells; and
performing, by the processor, a physical downlink shared channel (PDSCH) reception or a physical uplink shared channel (PUSCH) transmission with at least one of the plurality of cells based on the two-segment DCI.

2. The method of claim 1, further comprising:
receiving, by the processor, a radio resource control (RRC), a medium access control (MAC) control element (CE), a third DCI, or a pre-determined field number from the network node to configure which DCI field to be the common bit field and which DCI fields to be the plurality of designated bit fields.

3. The method of claim 1, further comprising:
performing, by the processor, a link procedure to link the first DCI with the second DCI as the two-segment DCI for performing the PDSCH reception or the PUSCH transmission with the at least one of the plurality of cells,
wherein the first DCI and the second DCI are decoded on a same cell before performing the link procedure, and the link procedure is operated to link the common bit field of the first DCI with one or more of the designated bit fields from the first DCI or from the second DCI as the two-segment DCI.

4. The method of claim 3, further comprising:
receiving, by the processor, a scheduling type of the first DCI or the second DCI from the network node; and
linking, by the processor, the common bit field of the first DCI with one or more of the designated bit fields from the first DCI or from the second DCI in an event that the scheduling types of the first DCI and the second DCI are the same.

5. The method of claim 3, further comprising:
receiving, by the processor, a DCI identification (ID) value or a carrier identification field (CIF) of the first DCI or of the second DCI from the network node; and
linking, by the processor, the common bit field of the first DCI with one or more of the designated bit fields from the first DCI or from the second DCI in an event that the first DCI and the second DCI have the same DCI ID value or the same CIF.

6. The method of claim 3, further comprising:
receiving, by the processor, a scrambling sequence of a demodulation reference signal (DMRS) scrambled physical downlink control channel (PDCCH) carrying the first DCI or the second DCI from the network node; and
linking, by the processor, the common bit field of the first DCI with one or more of the designated bit fields from the first DCI or from the second DCI in an event that the first DCI and the second DCI have the same scrambling sequence.

7. The method of claim 3, further comprising:
determining, by the processor, a reception symbol or a reception period of the first DCI or of the second DCI; and
linking, by the processor, the common bit field of the first DCI with one or more of the designated bit fields from the first DCI or from the second DCI in an event that the first DCI and the second DCI are received in the same reception symbol or in the same reception period.

8. The method of claim 3, further comprising:
receiving, by the processor, at least one fourth DCI from the network node; and
performing, by the processor, the link procedure to link the first DCI with the second DCI or with the at least one fourth DCI for performing the PDSCH reception or the PUSCH transmission with the at least one of the plurality of cells.

9. An apparatus, comprising:
a transceiver which, during operation, wirelessly communicates with a network node of a wireless network; and
a processor communicatively coupled to the transceiver such that, during operation, the processor performs operations comprising:
receiving a two-segment downlink control information (DCI) indicating a scheduling of a plurality of cells from a network node of a wireless network, wherein the two-segment DCI comprises a first DCI and a second DCI, the first DCI comprises a common bit field and a first part of a designated bit fields corresponding to at least one of the plurality of cells, and the second DCI comprises a second part of the designated bit fields corresponding to at least one of the plurality of cells; and
performing a physical downlink shared channel (PDSCH) reception or a physical uplink shared channel (PUSCH) transmission with at least one of the plurality of cells based on the two-segment DCI.

10. The apparatus of claim 9, wherein, during operation, the processor further performs operations comprising:
receiving a radio resource control (RRC), a medium access control (MAC) control element (CE), a third DCI, or a pre-determined field number from the network node to configure which DCI field to be the common bit field and which DCI fields to be the plurality of designated bit fields.

11. The apparatus of claim 9, wherein, during operation, the processor further performs operations comprising:
performing a link procedure to link the first DCI with the second DCI as the two-segment DCI for performing the PDSCH reception or the PUSCH transmission with the at least one of the plurality of cells,
wherein the first DCI and the second DCI are decoded on a same cell before performing the link procedure, and the link procedure is operated to link the common bit field of the first DCI with one or more of the designated bit fields from the first DCI or from the second DCI as the two-segment DCI.

12. The apparatus of claim 11, wherein, during operation, the processor further performs operations comprising:
receiving a scheduling type of the first DCI or the second DCI from the network node; and
linking the common bit field of the first DCI with one or more of the designated bit fields from the first DCI or from the second DCI in an event that the scheduling types of the first DCI and the second DCI are the same.

13. The apparatus of claim 11, wherein, during operation, the processor further performs operations comprising:
receiving a DCI identification (ID) value or a carrier identification field (CIF) of the first DCI or of the second DCI from the network node; and
linking the common bit field of the first DCI with one or more of the designated bit fields from the first DCI or from the second DCI in an event that the first DCI and the second DCI have the same DCI ID value or the same CIF.

14. The apparatus of claim 11, wherein, during operation, the processor further performs operations comprising:
receiving a scrambling sequence of a demodulation reference signal (DMRS) scrambled physical downlink control channel (PDCCH) carrying the first DCI or the second DCI from the network node; and
linking the common bit field of the first DCI with one or more of the designated bit fields from the first DCI or from the second DCI in an event that the first DCI and the second DCI have the same scrambling sequence.

15. The apparatus of claim 11, wherein, during operation, the processor further performs operations comprising:
determining a reception symbol or a reception period of the first DCI or of the second DCI; and
linking the common bit field of the first DCI with one or more of the designated bit fields from the first DCI or from the second DCI in an event that the first DCI and the second DCI are received in the same reception symbol or in the same reception period.

16. The apparatus of claim 11, wherein, during operation, the processor further performs operations comprising:
receiving, by the transceiver, at least one fourth DCI from the network node; and
performing the link procedure to link the first DCI with the second DCI or with the at least one fourth DCI for performing the PDSCH reception or the PUSCH transmission with the at least one of the plurality of cells.

17. A method, comprising:
configuring, by a processor of a network node, a two-segment downlink control information (DCI) indicating a scheduling of a plurality of cells, wherein the two-segment DCI comprises a first DCI and a second DCI, the first DCI comprises a common bit field and a first part of a designated bit fields corresponding to at least one of the plurality of cells, and the second DCI comprises a second part of the designated bit fields corresponding to at least one of the plurality of cells; and
transmitting, by the processor, the two-segment DCI to an apparatus of a wireless network to schedule a physical downlink shared channel (PDSCH) reception or a physical uplink shared channel (PUSCH) transmission with at least one of the plurality of cells based on the two-segment DCI.

18. The method of claim 17, further comprising:
transmitting, by the processor, a radio resource control (RRC), a medium access control (MAC) control element (CE), a third DCI, or a pre-determined field number to the apparatus to configure which DCI field to be the common bit field and which DCI fields to be the plurality of designated bit fields.

19. The method of claim 17, wherein:
the two-segment DCI is formed by performing a link procedure to link the first DCI with the second DCI,
the first DCI and the second DCI are decoded on a same cell before performing the link procedure, and
the link procedure is operated by the apparatus to link the common bit field of the first DCI with one or more of the designated bit fields from the first DCI or from the second DCI as the two-segment DCI.

20. The method of claim 17, further comprising:
transmitting, by the processor, a scheduling type of the first DCI or the second DCI to the apparatus;
transmitting, by the processor, a DCI identification (ID) value or a carrier identification field (CIF) of the first DCI or of the second DCI to the apparatus;
transmitting, by the processor, a scrambling sequence of a demodulation reference signal (DMRS) scrambled physical downlink control channel (PDCCH) carrying the first DCI or the second DCI to the apparatus;
transmitting, by the processor, at least one fourth DCI to the apparatus; or
configuring, by the processor, a transmission symbol or a transmission period of the first DCI or of the second DCI.
